(19) United States
(12) Patent Application Publication
(10) Pub. No.: US 2022/0212403 A1
(43) Pub. Date: Jul. 7, 2022

(54) 3D PRINT HEAD FOR FDM RUBBER MATERIAL AND 3D PRINTER USING SAME

(71) Applicant: Shenzhen AtomStack Technologies Co., Ltd., Shenzhen (CN)

(72) Inventors: Yun He, Shenzhen (CN); Huigang Lin, Shenzhen (CN); Zebin Li, Shenzhen (CN)

(21) Appl. No.: 17/564,203

(22) Filed: Dec. 28, 2021

Related U.S. Application Data
(63) Continuation of application No. PCT/CN2021/070249, filed on Jan. 5, 2021.

(51) Int. Cl. B29C 64/209; B29C 64/295; B33Y 30/00

(52) U.S. Cl. CPC B29C 64/209; B33Y 30/00; B29C 64/295

(57) ABSTRACT

The present invention discloses a 3D print head for FDM rubber material and a 3D printer using same. The 3D print head for FDM rubber material comprises a motor, a feeding assembly, a radiator, a heating block and an extrusion nozzle, and further comprises a venturi assembly. The venturi is installed between the radiator and the heating block by the mounting component, and a gap is formed between an upper end face of the venturi and the radiator. The motor drives the feeding assembly to feed material to the heating block through the venturi and extrude the material through the extrusion nozzle. The venturi of the present invention can greatly reduce the heat conduction through the venturi, to guarantee that thermo-plastic-rubber material used for printing is not softened and all the fed low-hardness and high-elasticity material can be effectively transferred before entering the heating block.

### CROSS REFERENCE TO RELATED APPLICATIONS

The present application is a Continuation Application of PCT Application No. PCT/CN2021/070249 filed on Jan. 5, 2021, the contents of which are incorporated herein by reference in their entirety.

### FIELD OF INVENTION

The present invention relates to the technical field of 3D printing, particularly relates to a 3D print head for FDM rubber material and a 3D printer using same.

### BACKGROUND ART OF THE INVENTION

An FDM technology in 3D printing refers to Fused Deposition Modeling (FDM) technology. Material used in FDM is usually thermo-plastic material, such as wax, ABS, nylon, etc. fed in a filamentary form, and heated and fused in a nozzle. The extruder moves along a section contour of a part and a filling track and extrudes the fused material. The material rapidly solidifies and condenses together with surrounding material. For most existing FDM printers adopting remote feeding, feeding motors are far away from nozzles and cannot feed soft material to the nozzles, so that majority printers can only print hard material, such as PLA, ABS and so on. For minority printers adopting proximal feeding, due to high temperature in feed channel and unreasonable design in material feeding path, only high-hardness thermo-plastic elastomer material with Shore hardness above 80A can be used for printing.

### DISCLOSURE OF THE INVENTION

A purpose of the present invention is to provide a 3D print head for FDM rubber material and a 3D printer using same, which can overcome the above-mentioned defects and use high-elasticity thermo-plastic-rubber material with Shore hardness below 80A for printing.

To achieve the above invention purpose, the present invention adopts following technical solution:

A 3D print head for FDM rubber material, comprising: a motor, a feeding assembly, a radiator, a heating block and an extrusion nozzle, and further comprising: a venturi assembly, the venturi assembly comprising a venturi made of material with good functions of high temperature resistance and heat conduction prevention and a mounting component, wherein the venturi is installed between the radiator and the heating block by the mounting component, a gap is formed between an upper end face of the venturi and the radiator; the motor drives the feeding assembly to feed a material to the heating block through the venturi and extrude the material through the nozzle.

Preferably, the mounting component comprises screws, wherein the screws are set into a group, one end of the group of screws is connected to the radiator, and the other end thereof is connected to the heating block.

Preferably, the mounting component further comprises set screws, wherein the set screws pass through the heating block and are abutted against the screws.

Preferably, the screw is provided with a recess, and the set screw passes through the heating block and is just located at the recess.

Preferably, the venturi is made of material with functions of high temperature resistance, good heat insulation and self-lubrication.

Preferably, the venturi is made of Teflon material.

Preferably, the feeding assembly is arranged in a position above the radiator.

Preferably, the feeding assembly comprises two feeding wheels: a driving feeding wheel, and a driven feeding wheel, wherein the driving feeding wheel is connected with an output shaft of the motor, and the material is just located between the driving feeding wheel and the driven feeding wheel, and is driven by the driving feeding wheel and the driven feeding wheel to move forward.

Preferably, the driving feeding wheel is a gear with teeth.

Preferably, the driven feeding wheel is provided with a groove in the middle.

Preferably, an arc structure is formed on an upper surface of the radiator, the arc structure is provided with two arch sections, the two arch sections are adapted to outer contours of the driving feeding wheel and the driven feeding wheel respectively, and a shape of an outer contour of an arc tip at a juncture of the two arch sections is exactly matched in a gap formed between the two feeding wheels correspondingly.

Preferably, the radiator is externally provided with two fans for heat dissipation through convection.

Preferably, the two fans for heat dissipation through convection are respectively: a blower fan for air intake and an extractor fan for air extraction.

Preferably, an air guide hood is installed below the extractor fan.

The present invention further provides a 3D printer, which comprises the 3D print head for 1-DM rubber material.

After adopting the above technical solution, the motor of the present invention is arranged in the print head, proximal feeding is realized, so high-elasticity rubber material with Shore hardness below 80A, for example, AtomStack Thermo-Plastic-Rubber (TPR) material, can be fed. Moreover, the venturi is made of Teflon material with good functions of high temperature resistance and heat insulation, a gap is formed between an upper end face of the venturi and the radiator, heat conduction through the venturi is greatly reduced, so the temperature of an entire feeding channel is greatly reduced, to guarantee that the material is not softened, the temperature of the portion above the heating block is low enough, and all the fed low-hardness and high-elasticity rubber material can be effectively transferred before entering the heating block.

### DESCRIPTION OF THE DRAWINGS

FIG. 1 is an assembly drawing of the present invention;

FIG. 2 is an operation diagram of the present invention;

FIG. 3 is an assembly drawing of a radiator and two fans of the present invention;

FIG. 4 is a schematic diagram of a radiator wrapped by two fans of the present invention; and

FIG. 5 is a top view of a driven feeding wheel of the present invention.

### DETAILED DESCRIPTION OF THE INVENTION

To make the technical solution and the advantages of the present invention more clear, the present invention will be further described below in detail in combination with the drawings and the embodiments. It should be understood that the specific embodiments described herein are only used for explaining the present invention, not used for limiting the present invention.

It should be noted in the description of the present invention that, unless otherwise specifically regulated and defined, terms such as “installation,” “connected,” and “connecting” shall be understood in broad sense, and for example, may refer to fixed connection or detachable connection or integral connection, may refer to mechanical connection or direct connection, For those ordinary skilled in the art, the specific meanings of the above terms in the present invention may be understood according to specific conditions.

### Embodiment 1

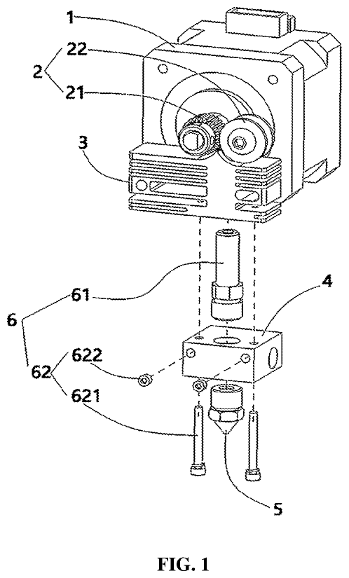

As shown in FIG. 1, the present invention provides a 3D print head for FDM rubber material, comprising a motor 1, a feeding assembly 2, a radiator 3, a heating block 4, an extrusion nozzle 5 and a venturi assembly 6.

In this embodiment, as shown in FIG. 1 and FIG. 5, the feeding assembly 2 is arranged in a position above the radiator 3, the feeding assembly 2 comprises two feeding wheels: a driving feeding wheel 21, and a driven feeding wheel 22; the driving feeding wheel 21 is connected with an output shaft of the motor 1. The driving feeding wheel 21 is a gear with teeth; the driven feeding wheel 22 is provided with a groove 221 in the middle.

An arc structure is formed on an upper surface of the radiator 3, the arc structure is provided with two arch sections, the two arch sections are adapted to outer contours of the driving feeding wheel 21 and the driven feeding wheel 22 respectively, and a shape of an outer contour of an arc tip at a juncture of the two arch sections is exactly matched in a gap formed between the two feeding wheels correspondingly. The arc structure formed on the upper surface of the radiator 3 minimizes the gap between the upper surface and the two feeding wheels, so the entire feeding channel is nearly closed and unobstructed in straight line, the material 7 may not deviate when high-elasticity material with Shore hardness below 80A is used for printing, being conducive to transmission of force during feeding.

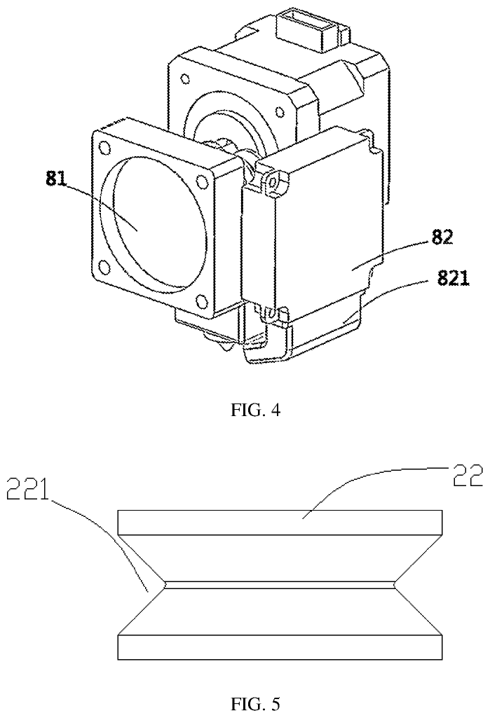

As shown in FIG. 3 and FIG. 4, the radiator 3 is externally provided with two fans for heat dissipation through convection. The two fans for heat dissipation through convection wrap the radiator 3. The two fans are respectively: a blower fan 81 for air intake and an extractor fan 82 for air extraction. An air guide hood 821 is installed below the extractor fan 82, and hot air extracted by the extractor fan 82 is guide out by the air guide hood 821, further reducing the temperature of the radiator 3 and the feeding channel.

As shown in FIG. 1, the venturi assembly 6 comprises a venturi 61 made of material with functions of high temperature resistance, good heat insulation and self-lubrication and a mounting component 62. In this embodiment, the venturi 61 is made of Teflon material.

The venturi 61 is installed between the radiator 3 and the heating block 4 by the mounting component 62, the venturi 61 is connected with the heating block 4 by threads thereof; a gap is formed between an upper end face of the venturi 61 and the radiator 3.

The mounting component 62 comprises screws 621 and set screws 622, wherein one end of each screw 621 is connected to the radiator 3, and the other end thereof is connected to the heating block 4. The set screws 622 pass through the heating block 4 and are abutted against the screws 621. The screw 621 is provided with a recess, and the set screw 622 passes through the heating block 4 and is just located at the recess, to prevent the screw 621 from becoming loose when passing through the heating block 4 and connecting to radiator 3, and strengthen positioning of the heating block 4 and the radiator 3. Moreover, because a gap is formed between an upper end face of the venturi 61 and the radiator 3, such design makes the venturi 61 free from axial pressure, to guarantee that the venturi is not deformed during use, and heat conduction through the venturi is greatly reduced, to guarantee that the material is not softened.

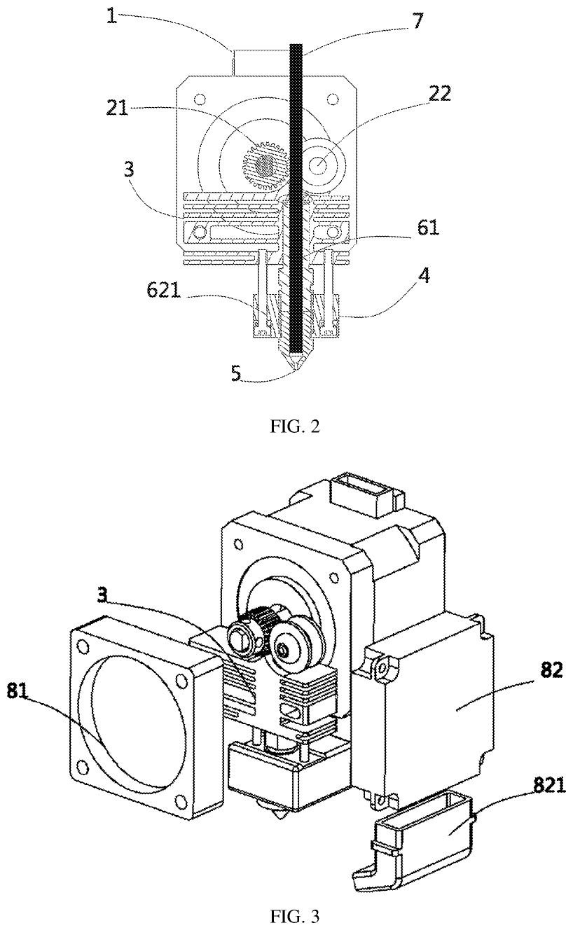

As shown in FIG. 2, proximal feeding is adopted in the present invention, after a print head is installed, high-elasticity material with Shore hardness below 80A is adopted for printing, the motor drives the feeding assembly 2 to feed the material 7 to the heating block 4 through the venturi 61 made of material with functions of high temperature resistance, good heat insulation and self-lubrication and extrude the material through the nozzle 5.

The motor 1 is started. The material 7 is just located between the driving feeding wheel 21 and the driven feeding wheel 22. The gear with teeth of the driving feeding wheel 21 increases an engagement force on the material 7, the groove 221 in the middle of the driven feeding wheel 22 makes a portion of the material 7 fall at the groove 221, the fed material of the material 7 is positioned to make the material 7 not slide and a downward movement route more precise. Through the engagement of the driving feeding wheel 21 and the positioning of the driven feeding wheel 22, such design also increases an impelling force on downward movement of the material 7.

The driving feeding wheel 21 and the driven feeding wheel 22 drive the material 7 to move downward. Since the arc structure formed on the upper surface of radiator 3 is matched with the outer contours of the two feeding wheels, the material 7 may not deviate and may directly enter the radiator 3. Below the radiator 3, heat is blocked by the venturi 61 made of material with functions of high temperature resistance, good heat insulation and self-lubricating, to prevent heat from being transferred to the radiator 3, and for the two fans for heat dissipation through convection that wrap the radiator 3, the blower fan blows hot air from the radiator 3 to the extractor fan to guide out the hot air through the air guide hood 821, so the material 7 may not be softened in a channel of the radiator 3 in advance.

The venturi 61 in the embodiment provided by the present application has functions of high temperature resistance and good heat insulation, and has a function of self-lubrication. After the material 7 successfully enters the venturi 61 from the channel of the radiator 3, the venturi 61 made of material with functions of high temperature resistance, good heat insulation and self-lubrication makes the material 7 more smoothly and rapidly pass through a channel of the venturi 61 with functions of high temperature resistance, good heat insulation and self-lubrication. In this embodiment, the venturi 61 with functions of high temperature resistance, good heat insulation and self-lubrication made of Teflon material makes the temperature of the feeding channel above the heating block 4 low enough, makes the material 7 be effectively transferred via a pushing force of the driving feeding wheel 21 and the driven feeding wheel 22 to successfully move downward until the material enters the heating block 4 and is extruded from the extrusion nozzle 5.

The high-elasticity material 7 for printing in the present application is preferably AtomStack Thermo-Plastic-Rubber (TPR) material, which is professional elastic rubber printing consumable, and has excellent performance in various aspects of physical property indexes, including strength, flexibility, resilience, weather resistance, fatigue resistance, non-toxicity, slip resistance, surface tactility, environmental protection (100% recyclable), high printing efficiency, low printing cost and so on. Of course, the high-elasticity material 7 for printing in the present application may be thermo-plastic elastomer (TPE) material which has characteristics of high strength, high resilience, injection molding, wide application range, environmental protection, non-toxicity, safety and excellent dyeing property, has excellent performance in soft tactility, weather resistance, fatigue resistance and temperature resistance, processability, and has advantages of no need of vulcanization, recycling and reduced cost.

A Shore hardness of the above-mentioned AtomStack TPR material is adjustable between 5-100A to meet requirements of the present application for high-elasticity rubber material 7 with Shore hardness below 80A, a high elasticity of the material is reflected in excellent mechanical properties, including elongation at break, tensile strength, tear strength, Ross flexing fatigue and the like, all of which have excellent performance. For example, when the AtomStack TPR material meets a Shore hardness of 65A required for extradition in the present application, various performance indexes thereof are shown in following table.

| TEST ITEM | | TEST | |
|---|---|---|---|
| PROPERTIES | UNIT | METHOD | METHOD |
| HARDNESS | shore | D2240 | 70 |
| | A | | |
| DENSITY (SPECIFIC GRAVITY) | — | D792 | 0.95 |
| ELONGATION | % | D412 | >500 |
| AT BREAK | | | |
| TENSILE STRENGTH | Mpa | D412 | 7.1 |
| TEAR STRENGTH | KN/m | D624 | 48 |
| ABRASION | mm³ | DIN53516 | 72 |
| ROSS FLEXING FATIGUE | cycles | D1052 | >200,000 |
| BAYSHO REREBOUND | % | D2632 | >50 |
| RESILIENCE | | | |
| TG | ° C. | D4065 | −60 |

The 3D print head for FDM rubber material of the present application is applied to a FDM printing technology with simple mechanical structure, low cost, easy maintenance and low printing environment requirements, in conjunction with the AtomStack TPR material used as a printing consumable, high-speed and high-flow printing with a printing efficiency much higher than that of flexible printing materials on the market can be realized, for example, when a layer thickness of the AtomStack TPR material used as a printing consumable is 0.3 mm, and an opening diameter of the nozzle is 0.8-1.0 mm, the printing speed can reach 50 mm/s.

### Embodiment 2

The present invention further provides a 3D printer, which comprises the 3D print head for FDM rubber material of embodiment 1.

The above contents are further detailed descriptions of the present invention in combination with specific embodiments. However, it cannot be considered that the specific embodiments of the present invention are only limited to these descriptions. For those ordinary skilled in the art to which the present invention belongs, several simple deductions or replacements may be made without departing from the conception of the present invention, all of which shall be considered to belong to the protection scope of the present invention.

What is claimed is:

1. A 3D print head for FDM rubber material, comprising: a motor (1), a feeding assembly (2), a radiator (3), a heating block (4) and an extrusion nozzle (5), and further comprising: a venturi assembly (6), the venturi assembly (6) comprising a venturi (61) made of material with good functions of high temperature resistance and heat conduction prevention and a mounting component (62), wherein the venturi (61) is installed between the radiator (3) and the heating block (4) by the mounting component (62), a gap is formed between an upper end face of the venturi (61) and the radiator (3); the motor (1) drives the feeding assembly (2) to feed a material (7) to the heating block (4) through the venturi (61) and extrude the material through the extrusion nozzle (5).

2. The 3D print head for FDM rubber material according to claim 1, characterized in that: the mounting component (62) comprises screws (621), wherein the screws (621) are set into a group, one end of the group of screws (621) is connected to the radiator (3), and the other end thereof is connected to the heating block (4).

3. The 3D print head for FDM rubber material according to claim 2, characterized in that: the mounting component (62) further comprises set screws (622), wherein the set screws (622) pass through the heating block (4) and are abutted against the screws (621).

4. The 3D print head for FDM rubber material according to claim 3, characterized in that: the screw (621) is provided with a recess, and the set screw (622) passes through the heating block (4) and is just located at the recess.

5. The 3D print head for FDM rubber material according to claim 1, characterized in that: the venturi (61) is made of material with functions of high temperature resistance, good heat insulation and self-lubrication.

6. The 3D print head for FDM rubber material according to claim 2, characterized in that: the venturi (61) is made of material with functions of high temperature resistance, good heat insulation and self-lubrication.

7. The 3D print head for FDM rubber material according to claim 3, characterized in that: the venturi (61) is made of material with functions of high temperature resistance, good heat insulation and self-lubrication.

8. The 3D print head for FDM rubber material according to claim 4, characterized in that: the venturi (61) is made of material with functions of high temperature resistance, good heat insulation and self-lubrication.

9. The 3D print head for FDM rubber material according to claim 5, characterized in that: the venturi (61) is made of Teflon material.

10. The 3D print head for FDM rubber material according to claim 9, characterized in that: the feeding assembly (2) is arranged in a position above the radiator (3).

11. The 3D print head for FDM rubber material according to claim 10, characterized in that: the feeding assembly (2) comprises two feeding wheels: a driving feeding wheel (21), and a driven feeding wheel (22), wherein the driving feeding wheel (21) is connected with an output shaft of the motor (1), and the material (7) is just located between the driving feeding wheel (21) and the driven feeding wheel (22), and is driven by the driving feeding wheel (21) and the driven feeding wheel (22) to move forward.

12. The 3D print head for FDM rubber material according to claim 11, characterized in that: the driving feeding wheel (21) is a gear with teeth.

13. The 3D print head for FDM rubber material according to claim 12, characterized in that: the driven feeding wheel (22) is provided with a groove (221) in the middle.

14. The 3D print head for FDM rubber material according to claim 11, characterized in that: an arc structure is formed on an upper surface of the radiator (3), the arc structure is provided with two arch sections, the two arch sections are adapted to outer contours of the driving feeding wheel (21) and the driven feeding wheel (22) respectively, and a shape of an outer contour of an arc tip at a juncture of the two arch sections is exactly matched in a gap formed between the two feeding wheels correspondingly.

15. The 3D print head for FDM rubber material according to claim 1, characterized in that: the radiator (3) is externally provided with two fans (8) for heat dissipation through convection that wrap the radiator (3).

16. The 3D print head for FDM rubber material according to claim 15, characterized in that: the two fans for heat dissipation through convection are respectively: a blower fan (81) for air intake and an extractor fan (82) for air extraction.

17. The 3D print head for FDM rubber material according to claim 16, characterized in that: an air guide hood (821) is installed below the extractor fan (82).

18. A 3D printer, comprising: the 3D print head for FDM rubber material of claim 1.
